(19) United States
(12) Patent Application Publication
(10) Pub. No.: US 2008/0135353 A1
(43) Pub. Date: Jun. 12, 2008

(54) Disc brakes

(76) Inventors: Yuichi Takeo, Toyota-shi (JP); Masaki Wake, Nishikamo-gun (JP)

Correspondence Address: BUCHANAN, INGERSOLL & ROONEY PC, POST OFFICE BOX 1404, ALEXANDRIA, VA, 22313-1404, US

(21) Appl. No.: 11/987,211

(22) Filed: Nov. 28, 2007

(30) Foreign Application Priority Data
Dec. 12, 2006 (JP) 2006-334253

(51) Int. Cl. F16D 55/226

(52) U.S. Cl. 188/73.39

(57) ABSTRACT

One aspect of the invention includes a disc brake including a pad and a supporting member movably supporting the pad. The supporting member includes a pair of torque receiving portions adjacent to ends of the pad for regulating movement of the pad in two circumference directions of a disc rotor. A first bias member is disposed between the pad and the supporting member and is capable of biasing the pad at all times from a side of the one torque receiving portion toward the other torque receiving portion. A second bias member is disposed between the pad and the supporting member and is capable of biasing the pad toward the other torque receiving portion only when the pad moving toward the one torque receiving portion. In addition, the first bias member and the second bias member bias different portions of the pad.

This application claims priority to Japanese patent application serial number 2006334253, the contents of which are incorporated herein by reference.

### BACKGROUND OF THE INVENTION

1. Field of the Invention

The present invention relates to a disc brake, which includes a pad that is pushed onto a disc rotor and includes a supporting member for movably supporting the pad. More particularly, the invention relates to a disc brake having a structure for suppressing a clonking noise, which could be made when the pad collides, at a braking time, against a torque receiving portion formed in the supporting member.

2. Description of the Related Art

A disc brake, as described in JP-A-10-331883 discloses a disc brake having a pair of pads, and a supporting member for supporting the pads. The supporting member is provided with two pairs of torque receiving portions. The torque receiving portions are adjacent to the two ends of the each pad in the circumference directions of a disc rotor. And the torque receiving portions regulate the movement of each pad. On one end side of each pad, moreover, there is mounted a leaf spring as an anti-rattle spring. This anti-rattle spring is integrally provided with first and second bias means. The first bias means is constituted to always bias the pad from one end side to the other end side thereby to push the pad onto the other side torque receiving portion, and the second bias means is constituted to suppress the movement of the pad only when the pad moves towards the one side end.

Therefore, the pad is pushed at a non-braking time onto the torque receiving portion by the first bias means. As a result, it is possible to suppress the clonking noise, which could be made by the collision of the pad against the torque receiving portion when the forward running vehicle is braked. At the time when the backward running vehicle is braked, moreover, the pad is suppressed on the movement to the side of the other torque receiving portion by the second bias means. As a result, the clonking noise, which could be made at the time when the backward running vehicle is braked, is suppressed. On the other hand, the second bias means is usually constituted not to bias the pad thereby not to augment the sliding resistance, which will occur between the pad and the supporting member. As a result, the second bias means does not make the pad difficult to move to the supporting member. Thus, the dragging phenomenon, as could be caused when the pad does not leave the disc rotor pad, is not augmented by the second bias means.

However, the anti-rattle spring has a complicated structure having the first bias means and the second bias means integrated, and is constituted by combining a plurality of straight portions and a plurality of curved portions. As a result, the product is required to have a strict shaping precision, which is problematic because the resulting functions are not sufficiently exhibited by plastic deformations due to slight precision errors or slight sags.

In the prior art, therefore, there has been needed a disc brake, which is provided with a simplified clonking noise preventing mechanism for preventing the clonking noise of a pad at the times when the forward running vehicle is braked and when the backward running vehicle is braked, and which has little or no effect on the dragging phenomenon of the pad.

### SUMMARY OF THE INVENTION

One aspect of the invention includes a disc brake including a pad and a supporting member movably supporting the pad. The supporting member includes a pair of torque receiving portions adjacent to ends of the pad for regulating movement of the pad in two circumference directions of a disc rotor. A first bias member is disposed between the pad and the supporting member and is capable of biasing the pad at all times from a side of the one torque receiving portion toward the other torque receiving portion. A second bias member is disposed between the pad and the supporting member and is capable of biasing the pad toward the other torque receiving portion only when the pad moving toward the one torque receiving portion. In addition, the first bias member and the second bias member bias different portions of the pad.

Therefore, the pad is pushed onto the side of the other torque receiving portion by the first bias member, when a vehicle is not braked. As a result, a clonking noise, which could be made by a collision of the pad against the other torque receiving portion when the forward running vehicle is braked, can be suppressed by the first bias member. In case the pad moves to the one torque receiving portion when the backward running vehicle is braked, the movement is restricted by the first and second bias members. This makes it possible to suppress a clonking noise, which could be made by a collision of the pad against the torque receiving portion.

Moreover, the second bias member is constituted to bias the pad only in case the pad moves toward the one torque receiving portion. As a result, the second bias member does not increase a sliding resistance of the pad to the supporting member so that increase in a dragging phenomenon of the pad on the disc rotor can be suppressed. Moreover, the first and second bias members take the mode, in which they bias the different portions of the pad. As a result, the structure of the bias members is made simpler than that of the prior art having the members integrated. Moreover, the first and second bias members are freed from the mutual affections of the plastic deformations due to manufacturing errors or sags, so that their performances can be stabilized.

### BRIEF DESCRIPTION OF THE DRAWINGS

FIG. 1 is a front view of a disc brake of the present invention;

FIG. 2 is a cross-sectional view taken along line II-II in FIG. 1;

FIG. 3 is a back view of the disc brake taken at arrow III in FIG. 2;

FIG. 4 is a cross-sectional view taken along line IV-IV in FIG. 2;

FIG. 5 is an enlarged view of a part of FIG. 4;

FIG. 6 is a cross-sectional view taken along line VI-VI in FIG. 5; and

FIG. 7 is a pad stroke-load diagram.

### DETAILED DESCRIPTION OF THE INVENTION

Each of the additional features and teachings disclosed above and below may be utilized separately or in conjunction with other features and teachings to provide improved disc brakes. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful configurations of the present teachings.

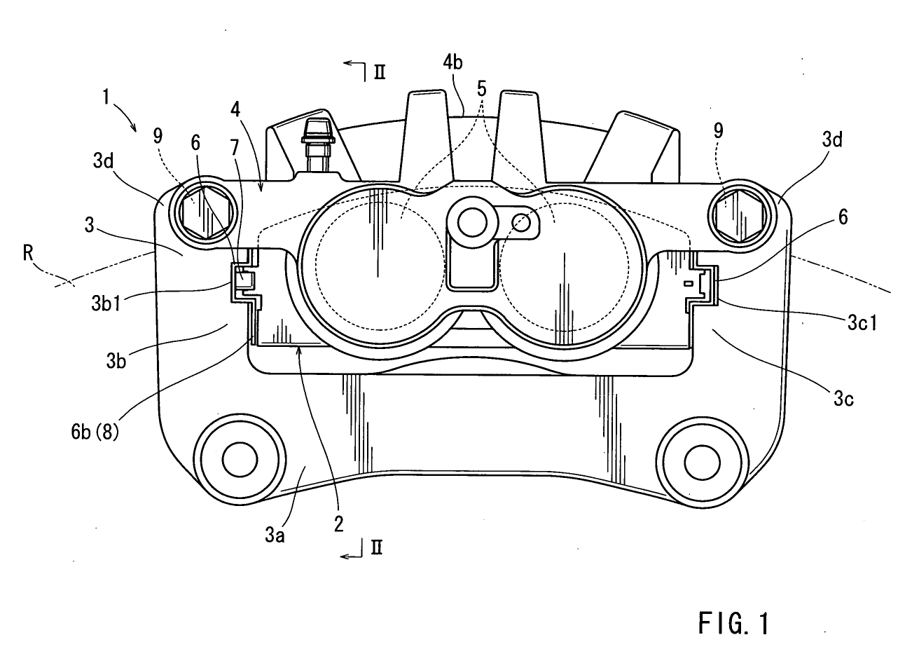

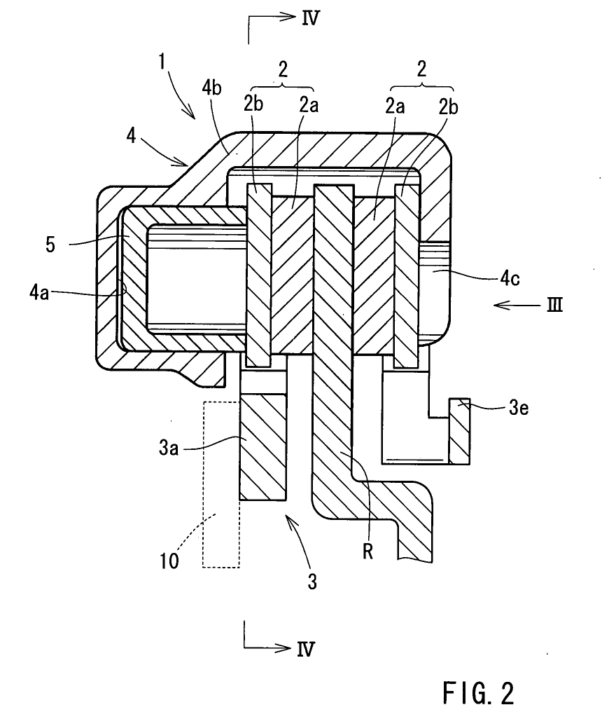

As shown in FIGS. 1 and 2, a disc brake 1 comprises a pair of pads 2, a mount (or a supporting member) 3 for supporting the pads 2 movably, and a caliper 4 movably mounted on the mount 3. On the two end sides of each pad 2, there are arranged pad supports 6 for preventing the pad 2 from sticking to the mount 3. Each pad 2 is provided on its one end side with bias member (or first bias member) 7 for biasing the pad 2 to the other end side.

The mount 3, as shown in FIGS. 1 and 2, includes a mounted portion 3a, a pair of inner-side torque receiving portions 3b and 3c, a pair of straddle portions 3d, a pair of outer-side torque receiving portions 3b and 3c and a connecting portion 3e. The mounted portion 3a is mounted on a vehicle-side member 10. The pair of inner-side torque receiving portions 3b and 3c extend in the rotor radial directions from the two ends of the mounted portion 3a. The pair of straddle portions 3d straddle in the rotor axis direction from the leading ends of the individual torque receiving portions 3b and 3c to the outside of the outer circumference of a disc rotor R. The pair of outer-side torque receiving portions 3b and 3c extend in the rotor radial directions from one end of each straddle portion 3d to the center side of the rotor radial direction. The connecting portion 3e connects the leading ends of the torque receiving portions 3b and 3c.

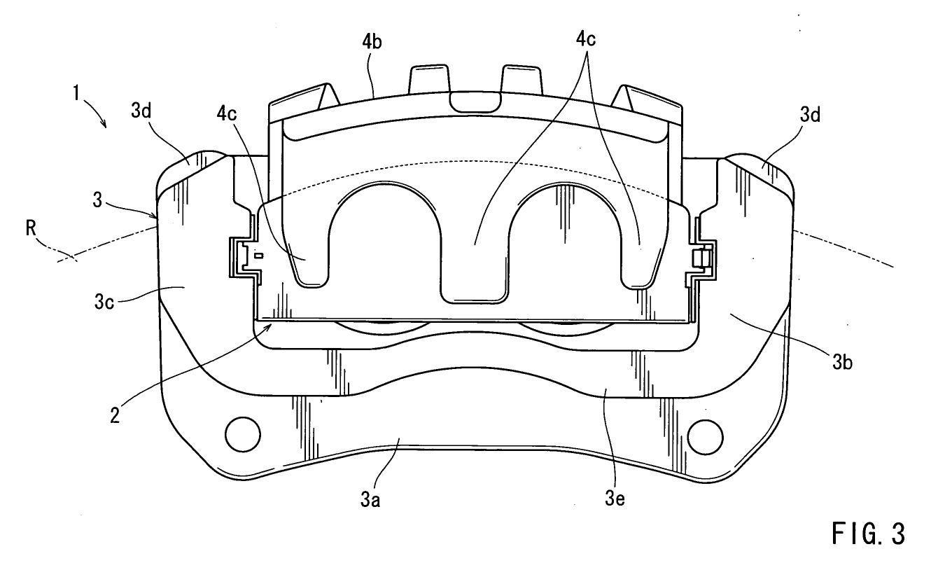

At the straddle portions 3d of the mount 3, as shown in FIG. 1, the caliper 4 is supported movably in the rotor axis direction through slide pins 9. As shown in FIG. 2, the caliper 4 is provided, on the vehicle-side portion, with a cylinder portion 4a for housing a piston 5. The caliper 4 is provided with a straddle portion 4b straddling the outside of the outer circumference of the disc rotor R in the rotor axis direction. At the leading end portion of the straddle portion 4b, as shown in FIG. 3, there are formed a plurality of pawls 4c, which extend in the rotor center direction.

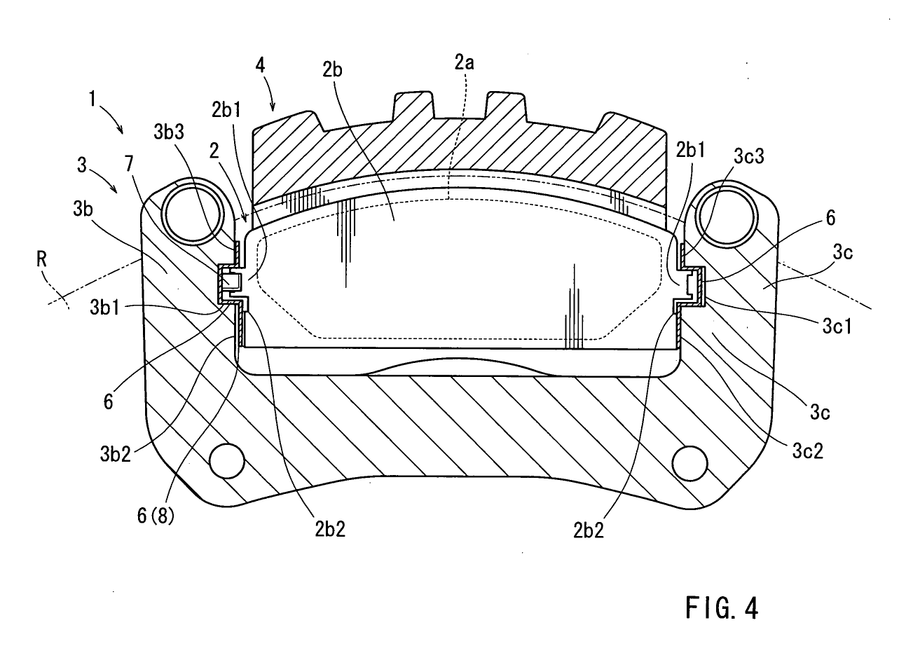

As shown in FIG. 2, the pad 2 includes a friction member 2a and a back plate 2b. The friction member 2a generates a braking force when it comes into sliding contact with the disc rotor R. The back plate 2b supports the back face of the friction member 2a. As shown in FIG. 4, the back plate 2b is provided, at the two end edges of the rotor circumference direction, with protrusions 2b1 and overhangs 2b2. The protrusions 2b1 and overhangs 2b2 protrude in the rotor circumference direction. The protrusions 2b1 are formed substantially at the centers of the end edges of the back plate 2b, and the overhangs 2b2 are formed at the positions closer to the rotor center side (i.e., at the lower-side positions of FIG. 4) than the protrusions 2b1.

As shown in FIG. 1, the pad 2, as disposed on the side closer to the vehicle than the disc rotor R, has its protrusions 2b1 mounted so movably on recesses 3b1 and 3c1 formed in the inner-side torque receiving portions 3b and 3c as to move in the rotor axis direction. As shown in FIG. 3, the pad 2, as disposed on the side more outside of the vehicle than the disc rotor R, has its protrusions 2b1 mounted so movably on recesses 3b1 and 3c1 formed in the outer-side torque receiving portions 3b and 3c as to move in the rotor axis direction.

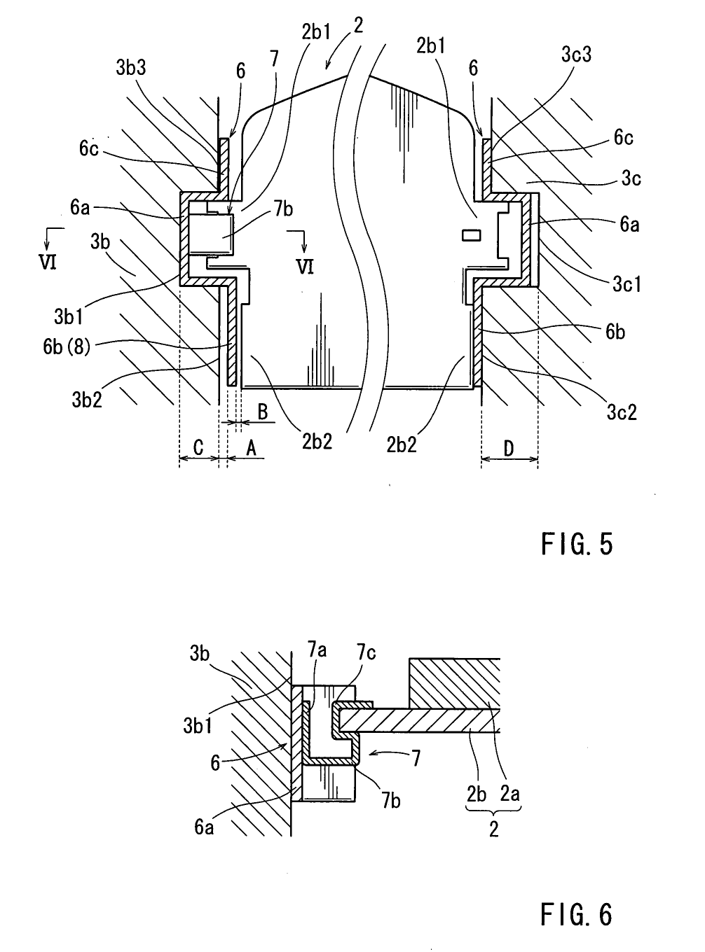

The pad support 6 is constructed of a leaf spring, as shown in FIGS. 4 and 5. The pad support 6 is integrally provided with an insert 6a, an extrusion 6b and an extension 6c. The insert 6a is inserted into the recesses 3b1 and 3c1. The extrusion 6b extends from the insert 6a inward the rotor center direction (i.e., downward of the drawing). The extension 6c extends from the insert 6a outward of the rotor radial direction (i.e., upward of the drawing). The extensions 6b and 6c extend along and between the torque receiving portions 3b and 3c and the pad 2. The pad supports 6, as disposed on the two end sides of the pad 2, can be made to have a similar shape.

As shown in FIG. 5, the torque receiving portions 3b and 3c are provided with the recesses 3b1 and 3c1, confronting faces 3b2, 3b3, 3c2 and 3c3. The confronting faces 3b2 and 3c2 confront the pad 2 at positions closer to the rotor center side than the recesses 3b1 and 3c1. The confronting faces 3b3 and 3c3 confront the pad 2 at positions more outside of the rotor radial direction than the recesses 3b1 and 3c1. The torque receiving portion 3b, as formed at the position on the rotor rotation-inlet side when the vehicle runs forward, has a distance C between the bottom face of the recess 3b1 and the confronting face 3b2. As a result, the insert 6a of the pad support 6 abuts against the bottom face of the recess 3b1 so that the extension 6b is spaced by a distance A (A≧0) from the torque receiving portion 3b.

As shown in FIG. 5, the extension 6b is usually spaced, too, by a distance B (B≧0) from the overhangs 2b2 of the pad 2. When the pad 2 moves to the side of the torque receiving portion 3b, the extension 6b is pushed and elastically deformed by the overhangs 2b2. Therefore, the extension 6b forms a second bias member 8 for biasing the pad 2. As a result, this second bias member 8 can absorb the energy, by which the pad 2 is brought into abutment against the torque receiving portion 3b. Thus, the second bias member 8 can suppress the clonking noise normally made at the torque receiving portion 3b by the pad 2.

As shown in FIG. 5, the torque receiving portion 3c on the rotor rotation outlet side (i.e., on the right side of FIG. 5), when the vehicle runs forward, has a distance D (D>C) between the bottom face of the recess 3c1 and the confronting face 3c2. As a result, the insert 6a of the pad support 6 does not come into contact with the bottom face of the recess 3c1, and the extension 6b does come into contact with the confronting face 3c2 of the torque receiving portion 3c. Therefore, the overhangs 2b2 of the pad 2 can be stably pushed through the extension 6b onto the torque receiving portion 3c.

As shown in FIG. 6, the bias member 7 is constructed of a leaf spring, and is provided with a fixed portion 7a, an extension 7b and a retained portion 7c. The fixed portion 7a is fixed on the bottom face of the recess 3b1 through the insert 6a, and the extension 7b extends from the fixed portion 7a while being curved and bent toward the end face of the back plate 2b of the pad 2. The retained portion 7c is formed at the leading end portion of the extension 7b, and is retained on the end of the back plate 2b. This bias member 7 is so interposed between the recess 3b1 and the protrusion 2b1 on the rotor rotation-inlet side (as located on the left side) when the vehicles runs forward, that the extension 7b is elastically deformed, as shown in FIGS. 4 and 5. Therefore, the bias member 7 biases the pad 2 at all times to the rotor rotation outlet side.

In case the braking force is to be generated by the disc brake 1, the vehicle-side pad 2 is pushed at first toward the disc rotor R by the piston 5, as shown in FIG. 2. By the reaction of this push, the caliper 4 is moved toward the vehicle side (or leftward) so that the pad 2 on the outer vehicle side is pushed onto the disc rotor R by the pawls 4c of the caliper 4. The pad 2 is regulated in its movement by the torque receiving portions 3b when the forward running vehicle is braked, although it is moved in the rotor circumference direction by the push of the disc rotor R.

When the forward running vehicle is braked, the pad 2 is pushed in advance onto the torque receiving portions 3c by the bias member 7. As a result, the bias member 7 suppresses the clonking noise, which could be made by the collision of the pad 2 against the torque receiving portions 3b. When the backward running vehicle is braked, on the other hand, the pad 2 moves leftward of FIG. 4 together with the disc rotor R against the bias member 7 so that the overhangs 2b2 pushes and deforms the second bias member 8 elastically. As a result, the pad 2 is pushed onto the torque receiving portion 3b while the collision against the torque receiving portion 3b being reduced by the elastic forces of the bias member 7 and the bias member 8. Thus, the bias member 7 and the bias member 8 reduces or prevents the clonking noise, which could be made at the backward running time of the vehicle.

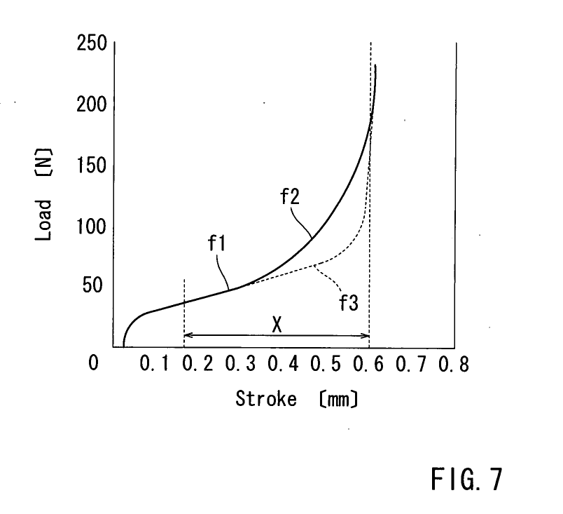

Measurements were experimentally made on the relations between the stroke and the load at the time when the pad 2 was moved against the bias member 7 and the second bias member 8. As a result, as shown in FIG. 7, the pad 2 receives loads from the bias member 7 at all times within an actual moving range X. Moreover, the load is received at f1 exclusively from the bias member 7, and at f2 from the bias member 7 and the second bias member 8. Within the range f2, therefore, there is received a load higher than that of f3, in which the force is received only from the bias member 7. Therefore, it is also found from FIG. 7 that the energy to impinge upon the torque receiving portion 3b of the pad 2 at the time of braking the backward running vehicle is reduced by the bias member 7 and the extension 6b.

As shown in FIG. 5, the pad 2 is constituted to receive no load from the second bias member 8 at a time of no braking or when the forward running vehicle is braked. In the pad 2, therefore, the sliding resistance to the mount 3 at a time of no braking or at the time of braking the forward running vehicle is not increased by the second bias member 8.

As shown in FIG. 4, the disc brake 1 includes the first bias member 7 for biasing the pad 2 at all times from the side of one torque receiving portion 3b to the other torque receiving portion 3c, and the second bias member 8 for biasing the pad 2 toward the other torque receiving portion 3c only when the pad 2 moves toward the one torque receiving portion 3b. Moreover, the first bias member 7 and the second bias member 8 bias the different portions of the pad 2.

As a result, the pad 2 is pushed onto the side of the other torque receiving portion 3c by the first bias member 7, as shown in FIG. 4, when the vehicle is not braked. Therefore, the clonking noise, which could be made by the collision of the pad 2 against the other torque receiving portion 3c when the forward running vehicle is braked, can be suppressed by the first bias member 7. In case the pad 2 moves to the one torque receiving portion 3b when the backward running vehicle is braked, the movement is restricted by the first and second bias members 7 and 8. This makes it possible to suppress or prevent the clonking noise, which could be made by the collision of the pad 2 against the torque receiving portion 3b.

Moreover, the second bias member 8 is constituted to bias the pad 2 only in case the pad 2 moves toward the one torque receiving portion 3b. As a result, the second bias member 8 does not increase the sliding resistance of the pad 2 to the mount (or the supporting member) 3, so that the increase in the dragging phenomenon of the pad 2 on the disc rotor R can be suppressed. Moreover, the first and second bias members 7 and 8 take the mode, in which they bias the different portions of the pad 2. As a result, the structure of the bias members is made simpler than that of the prior art having the members integrated. Moreover, the first and second bias members 7 and 8 are freed from the mutual affections of the plastic deformations due to manufacturing errors or sags, so that their performances can be stabilized.

As shown in FIG. 5, the first bias member 7 is arranged between the protrusion 2b1 formed on the one end side of the pad 2 and the recess 3b1 of the torque receiving portion 3b, into which that protrusion 2b1 is to be inserted. The second bias member 8 is disposed at a position near the recess 3b1 and between the torque receiving portion 3b and the pad 2. Therefore, the first and second bias members 7 and 8 bias the different portions of the pad 2.

Between the two end portions of the pad 2 and the torque receiving portions 3b and 3c confronting the end portions of the pad 2, as shown in FIG. 5, there are disposed the pad supports 6 for preventing the pad 2 from sticking to the torque receiving portions 3b and 3c. Each pad support 6 is provided with the insert 6a and the extension 6b. The insert 6a is inserted into the recesses 3b1 and 3c1 formed in the torque receiving portions 3b and 3c. The extension 6b extends from the insert 6a and between the torque receiving portions 3b and 3c and the pad 2.

The pad support 6, as arranged on the one end side (i.e., on the left side of FIG. 5) of the pad 2, is constituted such that the insert 6a contacts with the bottom face of the recess 3b1 whereas the extension 6b extends apart from but along the torque receiving portion 3b, thereby to form the second bias member 8. The pad support 6, as arranged on the other end side (i.e., on the right side of FIG. 5), is constituted such that the insert 6a does not contact with the bottom face of the recess 3c1 whereas the extension 6b contacts with the torque receiving portion 3c.

As shown in FIG. 5, the pad supports 6, as arranged at the two ends of the pad 2, have sectional configurations within a plane parallel to the disc rotor R. The configurations are symmetrical with each other with respect to a reference line. The reference line is a central line between the pad supports. This makes it possible to share the parts of the pad supports 6 disposed on the two ends of the pad 2. As a result, it is possible to suppress or prevents the increase in the manufacturing cost and to prevent the miss-assembly of the pad supports 6.

While the invention has been described with reference to specific configurations, it will be apparent to those skilled in the art that many alternatives, modifications and variations may be made. Accordingly, the present invention is intended to embrace all such alternatives, modifications and variations that may fall within the spirit and scope of the appended claims. For example, the present invention should not be limited to the representative configurations, but may be modified as described below.

In FIGS. 1, 2 and 3, the disc brake 1 is a floating type disc brake, in which mount (or the supporting member) 3 supports movably the pads 2, and the pistons are provided only at the vehicle side of the caliper 4. However, in another mode the disc brake may be a piston opposed type disc brake, in which the caliper movably supports the pads. The caliper can straddle the outside of the outer circumference of the disc rotor and is fixed on the member of the vehicle side. The pistons are provided at both sides of the caliper. In this mode, the caliper may be the supporting member.

In FIG. 5, the pad supports 6, as disposed on the two end sides of the pad 2, have the same shape, but the torque receiving portions 3b and 3c, as positioned on the two end sides of the pad 2, have different shapes. However, in another mode the torque receiving portions, as disposed on the two end sides of the pad, may have the same shape, while the pad supports, as positioned on the two end sides of the pad, have different shapes, so that the extension of one pad support may form the second bias member.

In FIG. 5, the pad support 6 and the bias member 7 are formed of the different members. However, in another mode they may be integrated, and the individual bias members bias the different portions of the pad.

This invention claims:

1. A disc brake comprising:
a pad having ends;
a supporting member capable of supporting the pad movably, the supporting member including a pair of torque receiving portions adjacent to the ends of the pad for regulating movement of the pad in two circumference directions relative to a disc rotor,
a first bias member disposed between the pad and the supporting member, the first bias member capable of biasing the pad at all times from a side of the one torque receiving portion toward the other torque receiving portion; and
a second bias member disposed between the pad and the supporting member, the second bias member capable of biasing the pad toward the other torque receiving portion only when the pad moving toward the one torque receiving portion;
wherein the first bias member and the second bias member bias different portions of the pad.

2. The disc brake as in claim 1, wherein: the first bias member is arranged between a protrusion formed on an end of the pad and a recess of the torque receiving portion, the protrusion being inserted into the recess.

3. The disc brake as in claim 2, wherein the second bias member is disposed at a position adjacent to the recess and between the torque receiving portion and the pad.

4. The disc brake as in claim 1, further including pad supports disposed between ends of the pad and the torque receiving portions, the pad supports preventing the pad from sticking to the torque receiving portions.

5. The disc brake as in claim 4, wherein each of the pad supports includes an insert positioned in a recess formed in the torque receiving portion, and an extension extending from the insert and between the torque receiving portion and the pad.

6. The disc brake as in claim 5, wherein one of the pad supports is configured to that the insert contacts a bottom face of the recess and the extension extends apart from but along the torque receiving portion to form the second bias member.

7. The disc brake as in claim 6, wherein the other of the pad supports is positioned opposite the one of the pad supports and is configured so that the insert does not contact with a bottom face of the recess whereas the extension contacts with the torque receiving portion.

8. The disc brake as in claim 7, wherein the pad supports have sectional configurations within a plane parallel to the disc rotor, further wherein the sectional configurations are symmetrical with each other with respect to a reference line.

9. A disc brake comprising:
a pad having ends;
a supporting member capable of supporting the pad movably, the supporting member including a pair of torque receiving portions adjacent to the ends of the pad for regulating movement of the pad in two circumference directions relative to a disc rotor,
a first bias member disposed between the pad and the supporting member, the first bias member capable of biasing the pad at all times from a side of the one torque receiving portion toward the other torque receiving portion; and
a second bias member disposed between the pad and the supporting member, the second bias member capable of biasing the pad toward the other torque receiving portion only when the pad moving toward the one torque receiving portion;
wherein the first bias member and the second bias member bias different portions of the pad, further wherein the first bias member is arranged between a protrusion formed on an end of the pad and a recess of the torque receiving portion, the protrusion being inserted into the recess, and the second bias member is disposed at a position adjacent to the recess and between the torque receiving portion and the pad.

10. The disc brake as in claim 9, further including pad supports disposed between ends of the pad and the torque receiving portions, the pad supports preventing the pad from sticking to the torque receiving portions.

11. The disc brake as in claim 10, wherein each of the pad supports includes an insert positioned in a recess formed in the torque receiving portion, and an extension extending from the insert and between the torque receiving portion and the pad.

12. The disc brake as in claim 11, wherein one of the pad supports is configured to that the insert contacts a bottom face of the recess and the extension extends apart from but along the torque receiving portion to form the second bias member,

13. The disc brake as in claim 12, wherein the other of the pad supports is positioned opposite the one of the pad supports and is configured so that the insert does not contact with a bottom face of the recess whereas the extension contacts with the torque receiving portion.

14. The disc brake as in claim 13, wherein the pad supports have sectional configurations within a plane parallel to the disc rotor, further wherein the sectional configurations are symmetrical with each other with respect to a reference line.

15. A disc brake comprising:
a pad having ends;
a supporting member capable of supporting the pad movably, the supporting member including a pair of torque receiving portions adjacent to the ends of the pad for regulating movement of the pad in two circumference directions relative to a disc rotor,
a first bias member disposed between the pad and the supporting member, the first bias member capable of biasing the pad at all times from a side of the one torque receiving portion toward the other torque receiving portion; and
a second bias member disposed between the pad and the supporting member, the second bias member capable of biasing the pad toward the other torque receiving portion only when the pad moving toward the one torque receiving portion;
wherein the first bias member and the second bias member bias different portions of the pad, further wherein the first bias member is arranged between a protrusion formed on an end of the pad and a recess of the torque receiving portion, the protrusion being inserted into the recess, and the second bias member is disposed at a position adjacent to the recess and between the torque receiving portion and the pad,
further including pad supports disposed between ends of the pad and the torque receiving portions, the pad supports preventing the pad from sticking to the torque receiving portions, wherein:
each of the pad supports includes an insert inserted into a recess formed in the torque receiving portion, and an extension extending from the insert and between the torque receiving portion and the pad, wherein one of the pad supports, as arranged on one end side of the pad, is constituted such that the insert contacts with a bottom face of the recess whereas the extension extends apart from but along the torque receiving portion, thereby to form the second bias member

16. The disc brake as in claim 15, wherein the other of the pad supports, as arranged on the other end side of the pad, is constituted such that the insert does not contact with a bottom face of the recess whereas the extension contacts with the torque receiving portion.

17. The disc brake as in claim 16, wherein the pad supports, as arranged at the ends of the pad, have sectional configurations within a plane parallel to the disc rotor, the configurations are symmetrical with each other with respect to a reference line.
